(19) United States
(12) Patent Application Publication
(10) Pub. No.: US 2020/0393250 A1
(43) Pub. Date: Dec. 17, 2020

(54) ENHANCED ROUTE PLANNING

(71) Applicant: Ford Global Technologies, LLC, Dearborn, MI (US)

(72) Inventors: Kenneth J. MILLER, Canton, MI (US); Aed M. DUDAR, Canton, MI (US); Thomas G. LEONE, Ypsilanti, MI (US)

(21) Appl. No.: 16/763,035

(22) PCT Filed: Nov. 17, 2017
(86) PCT No.: PCT/US2017/062136

§ 371 Date: May 11, 2020

(51) Int. Cl. G01C 21/20; G01C 21/34

(52) U.S. Cl. CPC G01C 21/206; B60W 60/00253; G01C 21/3407

(57) ABSTRACT

A computer is programmed to estimate a total travel time for a vehicle from a current location in a multilevel structure to a destination. The estimated total travel time includes a sum of an estimated travel time from a specified point at the multilevel structure to the destination and estimated travel times for each level of the multilevel structure from a level of the current location to the specified point.

### BACKGROUND

Estimating a travel time for a vehicle between two points has many uses, such as choosing which vehicle to dispatch for a ride-hailing service, providing guidance to a driver of a vehicle, and choosing a route for an autonomous vehicle. Current techniques of estimating travel times typically use a two-dimensional map for evaluating a planned route. Thus, current techniques do not take into account a vertical position of a vehicle relative to the ground level, such as within a multilevel structure such as a parking garage.

### BRIEF DESCRIPTION OF THE DRAWINGS

FIG. 1 is a block diagram of an example vehicle.

FIG. 2 is a diagram of the vehicle in an example multilevel structure.

FIG. 3 is a process flow diagram of an example process for estimating a travel time including time spent in the multilevel structure.

FIG. 4 is a process flow diagram of an example process for estimating travel times for each level of the multilevel structure that is smart.

FIG. 5 is a process flow diagram of an example process for estimating travel times for each level of the multilevel structure based on historical data.

FIG. 6 is a process flow diagram of an example process for estimating travel times for each level of the multilevel structure based on data about the surrounding area.

### DETAILED DESCRIPTION

A system includes a computer. The computer is programmed to estimate a total travel time for a vehicle between an inside location in a multilevel structure and an outside location. The estimated total travel time includes a sum of an estimated travel time between a specified point at the multilevel structure and the outside location and estimated travel times for each level of the multilevel structure between a level of the inside location and the specified point.

The estimated total travel time may further include an estimated transition time one of into and out of the multilevel structure.

The computer may be programmed to calculate the estimated travel times for each level based on turnover data for the multilevel structure. The computer may be programmed to calculate the estimated travel times for each level based on turnover data for each level.

The computer may be programmed to calculate the estimated travel times for each level based on historical average travel times for the levels. The historical average travel times may be based on a current date and time. The historical average travel times may be based on whether a special event is occurring. The computer may be programmed to calculate the estimated travel times for each level based on historical average travel times for the levels upon determining that turnover data for the multilevel structure is unavailable.

The computer may be programmed to calculate the estimated travel times for each level based on one of population density and average traffic delay times of an area including the multilevel structure. The computer may be programmed to calculate the estimated travel times for each level based on one of population density and average traffic delay times of an area including the multilevel structure upon determining that one of turnover data for the multilevel structure and historical average travel times for the levels is unavailable.

A method includes estimating a total travel time for a vehicle between an inside location in a multilevel structure and an outside location. The estimated total travel time includes a sum of an estimated travel time between a specified point at the multilevel structure and the outside location and estimated travel times for each level of the multilevel structure between a level of the inside location and the specified point.

The estimated total travel time may further include an estimated transition time one of into and out the multilevel structure.

The method may include calculating the estimated travel times for each level based on turnover data for the multilevel structure. The method may include calculating the estimated travel times for each level based on turnover data for each level.

The method may include calculating the estimated travel times for each level based on historical average travel times for the levels. The historical average travel times may be based on a current date and time. The historical average travel times may be based on whether a special event is occurring. The method may include calculating the estimated travel times for each level based on historical average travel times for the levels upon determining that turnover data for the multilevel structure is unavailable.

The method may include calculating the estimated travel times for each level based on one of population density and average traffic delay times of an area including the multilevel structure. The method may include calculating the estimated travel times for each level based on one of population density and average traffic delay times of an area including the multilevel structure upon determining that one of turnover data for the multilevel structure and historical average travel times for the levels is unavailable.

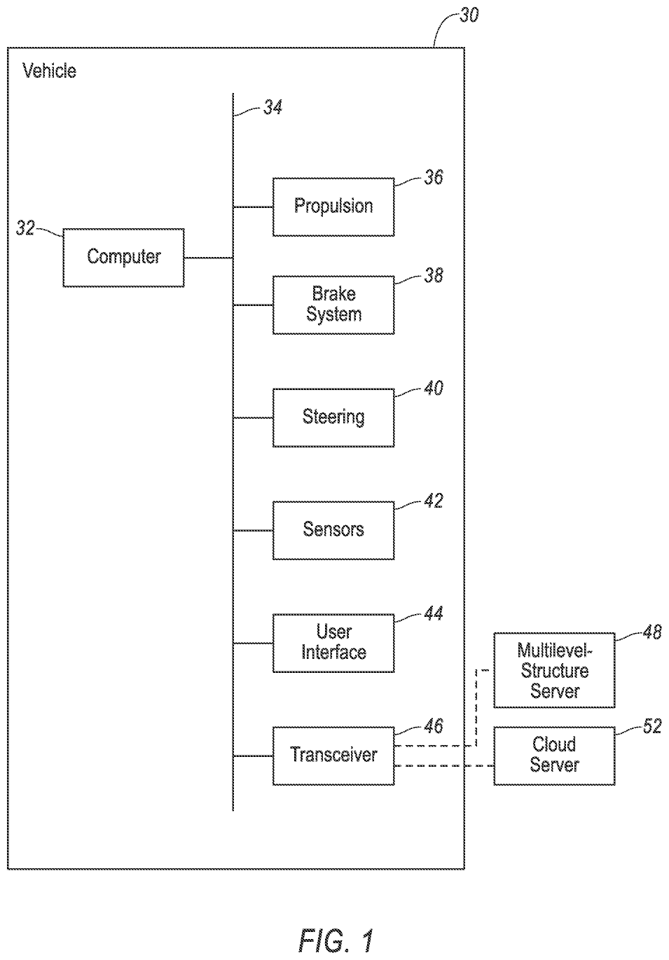

With reference to FIG. 1, the vehicle 30 may be an autonomous vehicle. A computer 32 can be configured to operate the vehicle 30 independently of the intervention of a human driver, completely or to a lesser degree. The computer 32 may be programmed to operate a propulsion 36, a steering 40, a brake system 38, and/or other vehicle systems. For the purposes of this disclosure, autonomous operation means the computer 32 controls the propulsion 36, steering 40, and brake system 38; semi-autonomous operation means the computer 32 controls one or two of the propulsion 36, steering 40, and brake system 38 and a human driver controls the remainder; and nonautonomous operation means the human driver controls the propulsion 36, steering 40, and brake system 38.

The computer 32 is a microprocessor-based computer. The computer 32 includes a processor, memory, etc. The memory of the computer 32 includes memory for storing instructions executable by the processor as well as for electronically storing data and/or databases.

The computer 32 may transmit and receive data through a communications network 34 such as a controller area network (CAN) bus, Ethernet, WiFi, Local Interconnect Network (LIN), onboard diagnostics connector (OBD-II), and/or by any other wired or wireless communications network. The computer 32 may be in communication with the propulsion 36, the steering 40, the brake system 38, sensors 42, a user interface 44, a transceiver 46, and/or other components via the communications network 34.

The propulsion 36 of the vehicle 30 generates energy and translates the energy into motion of the vehicle 30. The propulsion 36 may be a known vehicle propulsion subsystem, for example, a conventional powertrain including an internal-combustion engine coupled to a transmission that transfers rotational motion to wheels; an electric powertrain including batteries, an electric motor, and a transmission that transfers rotational motion to the wheels; a hybrid powertrain including elements of the conventional powertrain and the electric powertrain; or any other type of propulsion. The propulsion 36 can include an electronic control unit (ECU) or the like that is in communication with and receives input from the computer 32 and/or a human driver. The human driver may control the propulsion 36 via, e.g., an accelerator pedal and/or a gear-shift lever.

The steering 40 is typically a known vehicle steering subsystem and controls the turning of the wheels. The steering 40 may be a rack-and-pinion system with electric power-assisted steering, a steer-by-wire system, as both are known, or any other suitable system. The steering 40 can include an electronic control unit (ECU) or the like that is in communication with and receives input from the computer 32 and/or a human driver. The human driver may control the steering 40 via, e.g., a steering wheel.

The brake system 38 is typically a known vehicle braking subsystem and resists the motion of the vehicle 30 to thereby slow and/or stop the vehicle 30. The brake system 38 may include friction brakes such as disc brakes, drum brakes, band brakes, etc.; regenerative brakes; any other suitable type of brakes; or a combination. The brake system 38 can include an electronic control unit (ECU) or the like that is in communication with and receives input from the computer 32 and/or a human driver. The human driver may control the brake system 38 via, e.g., a brake pedal.

The sensors 42 may provide data about operation of the vehicle 30, for example, wheel speed, wheel orientation, and engine and transmission data (e.g., temperature, fuel consumption, etc.). The sensors 42 may detect the location and/or orientation of the vehicle 30. For example, the sensors 42 may include global positioning system (GPS) sensors; accelerometers such as piezo-electric or microelectromechanical systems (MEMS); gyroscopes such as rate, ring laser, or fiber-optic gyroscopes; inertial measurements units (IMU); and magnetometers. The sensors 42 may detect the external world, e.g., objects and/or characteristics of surroundings of the vehicle 30, such as other vehicles, road lane markings, traffic lights and/or signs, pedestrians, etc. For example, the sensors 42 may include radar sensors, scanning laser range finders, light detection and ranging (LIDAR) devices, and image processing sensors such as cameras.

With continued reference to FIG. 1, the user interface 44 presents information to and receives information from an occupant of the vehicle 30. The user interface 44 may be located, e.g., on an instrument panel in a passenger cabin of the vehicle 30, or wherever may be readily seen by the occupant. The user interface 44 may include dials, digital readouts, screens, speakers, and so on for providing information to the occupant, e.g., human-machine interface (HMI) elements such as are known. The user interface 44 may include buttons, knobs, keypads, touchscreen, microphone, and so on for receiving information from the occupant.

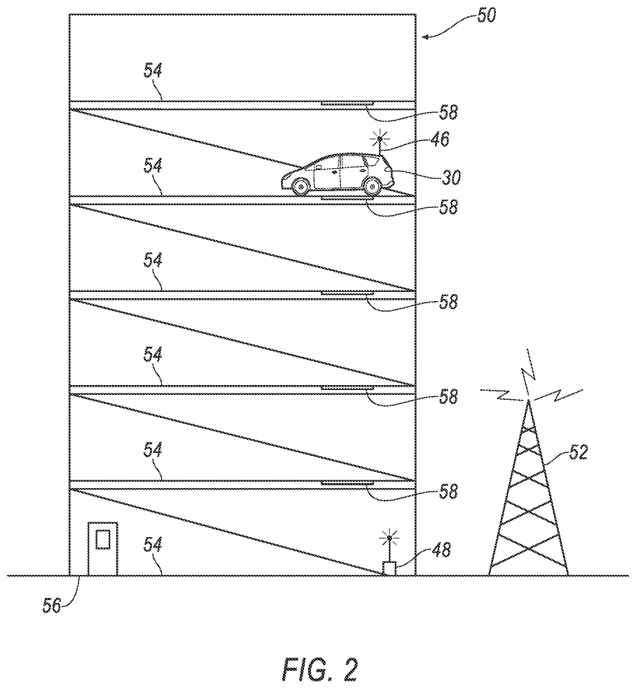

With reference to FIGS. 1 and 2, the transceiver 46 may be adapted to transmit signals wirelessly through any suitable wireless communication protocol, such as Bluetooth®, WiFi, IEEE 802.11a/b/g, other RF (radio frequency) communications, etc. The transceiver 46 may be one device or may include a separate transmitter and receiver. The transceiver 46 may be adapted to communicate with a remote server, that is, a server distinct and spaced from the vehicle 30. The remote server may be located outside the vehicle 30. For example, the remote server may be associated with other vehicles (e.g., V2V communications via Dedicated Short-Range Communications (DSRC) or the like), infrastructure components (e.g., V2I communications), emergency responders, mobile devices associated with the owner of the vehicle 30, etc. Specifically, the remote server may be a multilevel-structure server 48 associated with a multilevel structure 50, and/or a cloud server 52 in communication with several vehicles, each described below.

With reference to FIG. 2, the vehicle 30 may be located in the multilevel structure 50. For the purposes of this disclosure, a “multilevel structure” is defined as a structure having at least two surfaces on which vehicles can drive that are arranged one above the other. For example, the multilevel structure 50 may be a parking garage (as shown in FIG. 2), a vehicle waiting area at an airport, etc. Each driving surface that does not extend above itself is one level 54. For example, if a multilevel structure 50 is arranged in a spiral, a new level 54 begins when a ramp extends above a lower level 54. The cutoff on a ramp between levels 54 may be specified arbitrarily by the multilevel structure 50 or may be specified by rules stored by the computer 32, such as beginning a new level 54 when the level 54 extends above an entrance point to the multilevel structure 50.

Locations in the multilevel structure 50 may be specified in terms of longitude and latitude or other two-dimensional coordinates as measured on a map, as well as altitude or height, which may be specified in terms of the level 54 of the multilevel structure 50. A specified point 56 may be defined by the computer 32 as where the multilevel structure 50 connects to the environment outside the multilevel structure 50; for example, the specified point 56 may be the entrance and/or exit of the multilevel structure 50. The specified point 56 may be specified by two-dimensional coordinates and a height of a first level 54 of the multilevel structure 50.

The multilevel structure 50 may be a “smart” multilevel structure 50, meaning the multilevel structure 50 includes a multilevel-structure server 48 able to communicate with the computer 32 via signals sent to and received from the transceiver 46. The multilevel structure 50 may include load cells 58 positioned below respective parking spaces. The load cells 58 may sense weight; for example, the load cells 58 may be transducers that generate an electrical signal proportional to an experienced force. Each load cell 58 thus may detect whether a vehicle is occupying the parking space. The load cells 58 may be in communication with the multilevel-structure server 48. Alternatively or additionally, the multilevel structure 50 may include sensors such as cameras having the parking spaces in a field of view. The multilevel-structure server 48 may use conventional object-detection algorithms to detect which parking spaces are occupied.

The cloud server 52 may be in communication with the computer 32 via signals, e.g., RF communications according to a protocol such as mentioned above, sent to and received from the transceiver 46. The cloud server 52 may be in communication with several vehicles, such as all vehicles whose owners have registered for a particular service. The cloud server 52 may aggregate data from the several vehicles, e.g., current and previous locations and velocities. For example, the cloud server 52 may collect and average times to traverse the levels 54 of the multilevel structure 50 correlated with times of day and days of the week. For another example, the cloud server 52 may collect and average two-dimensional positions and velocities correlated with times of day and days of the week, which is useful for determining traffic busyness.

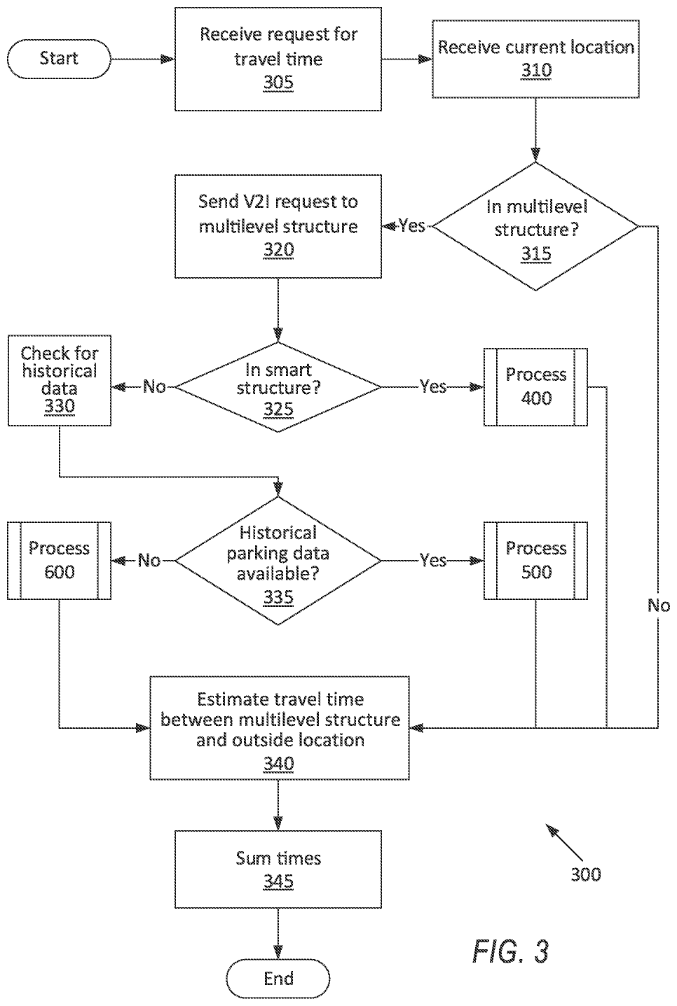

FIG. 3 is process flow diagram illustrating an exemplary process 300 for estimating a travel time including time spent in the multilevel structure 50. The memory of the computer 32 stores executable instructions for performing the steps of the process 300. Alternatively or additionally, the executable instructions may be stored and performed on a remote server such as the cloud server 52.

The process 300 begins in a block 305, in which the computer 32 receives a request for a travel time for the vehicle 30 from a current location to a destination. The request may come from an occupant via the user interface 44, or the request may come from another application (i.e., set of program instructions) running on the computer 32, such as a virtual driver, i.e., autonomous-driving module. The request may specify the destination.

Next, in a block 310, the computer 32 receives the current location of the vehicle 30. The current location is where the vehicle 30 is, including longitude and latitude or another two-dimensional position as measured on a map, as well as altitude or height, which may be specified in terms of the level 54 of the multilevel structure 50. The current location may be received from, e.g., the sensors 42 such as a GPS sensor, communication over V2I protocols with nearby infrastructure components, such as the multilevel-structure server 48, and/or image recognition applied to walls of the multilevel structure 50. The computer 32 may use known object recognition techniques to recognize numerals and/or other markings on the walls, floor, and/or ceiling, etc., of the multilevel structure 50 in data received from cameras of the sensors 42 of the vehicle 30 to determine a current level 54 of the vehicle 30.

Next, in a decision block 315, the computer 32 determines whether the current location or the destination is in the multilevel structure 50. The computer 32 may compare the longitude and latitude of the current location and the destination with map data. Additionally, the computer 32 may determine whether attempted V2I communications with the multilevel-structure server 48 have been successful. Whichever of the current location and the destination is located in the multilevel structure 50 is referred to as an inside location, and whichever or both of the current location and the destination is not located in the multilevel structure 50 is referred to as an outside location. The inside location may be internal to the multilevel structure 50 or may be exposed, e.g., on an uncovered top level 54 of the multilevel structure 50. If neither the current location nor the destination is in the multilevel structure 50, the process 300 proceeds to a block 340.

Next, if the current location or the destination is in the multilevel structure 50, i.e., if one of the current location or the destination is an inside location, in a block 320, the computer 32 sends a V2I request via the transceiver 46 to the multilevel-structure server 48 requesting turnover data for the multilevel structure 50. Turnover data, discussed more fully below, are one or more metrics measuring a current busyness of the multilevel structure 50.

Next, in a decision block 325, the computer 32 determines whether the inside location is in a multilevel structure 50 that tracks parking within itself, i.e., whether turnover data is available from the multilevel-structure server 48. The computer 32 determines whether the multilevel-structure server 48 has responded to the V2I request by sending the turnover data. The turnover data is not available if the multilevel structure 50 does not track such information or if the multilevel structure 50 does not have a multilevel-structure server 48. If the turnover data is available, the process 300 proceeds to the start of a process 400. As described below, in the process 400, the computer 32 receives the turnover data as an input and determines estimated travel times for each level 54 between the inside location and the specified point 56. After the process 400 ends, the process 300 proceeds to the block 340.

If the turnover data is not available, next, after the decision block 325, in a block 330, the computer 32 checks for historical average travel times for the multilevel structure 50. For example, the computer 32 may send a request via the transceiver 46 to the cloud server 52 for historical average travel times for the multilevel structure 50. Historical average travel times are metrics aggregating actual travel times by vehicles from, e.g., one level 54 of the multilevel structure 50 to the next level 54 above or below.

Next, in a decision block 335, the computer 32 determines whether the historical average travel times are available. For example, the computer 32 determines whether a response was received from the cloud server 52 indicating that the historical average travel times exist for the multilevel structure 50. If the historical average travel times are available, the process 300 proceeds to the start of a process 500. As described below, in the process 500, the computer 32 uses the historical average travel times to determine estimated travel times for each level 54 between the inside location and the specified point 56. If the historical average travel times are unavailable, the process 300 proceeds to the start of a process 600. As described below, in the process 600, the computer 32 uses data about the geographic area surrounding the multilevel structure 50 to determine estimated travel times for each level 54 between the inside location and the specified point 56. After the process 500 or 600 ends, the process 300 proceeds to the block 340.

If neither the current location nor the destination is in the multilevel structure 50, after the decision block 315, or after the process 400, 500 or 600, in the block 340, the computer 32 estimates a travel time between the specified point 56 at the multilevel structure 50 and the outside location (or between two outside locations). The computer 32 may use known techniques such as using speed limits, intersection types, real-time traffic data, etc., along a planned route to estimate the travel time.

Next, in a block 345, the computer 32 determines an estimated total travel time by summing the estimated travel time between the specified point 56 and the outside location, as determined in the block 340, with the estimated travel times for each level 54 of the multilevel structure 50 between the level 54 of the inside location and the specified point 56 and the estimated transition time for the multilevel structure 50, as determined in the process 400, the process 500, or the process 600. For the purposes of this disclosure, the “transition time” is defined as the time between the specified point 56 and traversing the level 54 of the specified point 56, i.e., time to enter or exit the multilevel structure 50, e.g., time spent collecting a ticket at an entrance, time spent traveling through a booth collecting parking fees for the multilevel structure 50, etc. After the block 345, the process 300 ends.

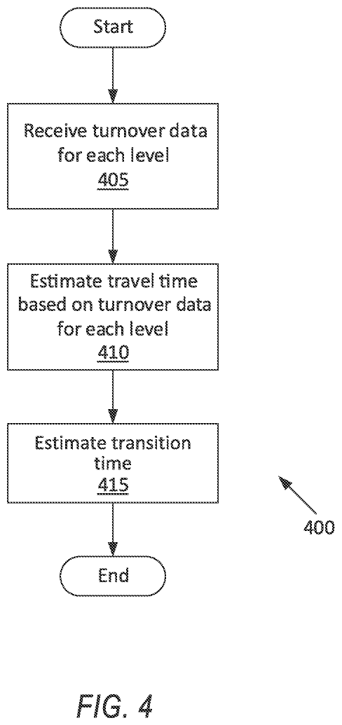

FIG. 4 is process flow diagram illustrating an exemplary process 400 for estimating travel times for each level 54 of the multilevel structure 50 that collects turnover data. The process 400 may be called as part of the process 300 or independently. The memory of the computer 32 stores executable instructions for performing the steps of the process 400. Alternatively or additionally, the executable instructions may be stored and performed on a remote server such as the cloud server 52.

The process 400 begins in a block 405, in which the computer 32 receives turnover data from the multilevel-structure server 48. Turnover data are one or more metrics measuring a current busyness of the multilevel structure 50. For example, the turnover data may be a rate of vehicles entering parking spots, a rate of vehicles exiting parking spots, a rate of change of parked vehicles, a combination of these metrics, etc. The turnover data may be for each level 54 or for the multilevel structure 50 as a whole. The turnover data may be determined over a period of time up to the current time, such as the past half hour. The period of time may be chosen to be long enough for sufficient data to accumulate for accurate and short enough that the data is particular to the current time of day. The turnover data may also include, e.g., rates of entering and/or exiting the multilevel structure 50.

Next, in a block 410, the computer 32 estimates the travel time for each level 54 between the level 54 of the inside location and the specified point 56 based on the turnover data for the multilevel structure 50, either for particular levels 54 or for the multilevel structure 50 as a whole. The memory of the computer 32 may store a table of estimated travel times corresponding to values of one of the metrics of turnover data. The table may be based on historical data from which average travel times may be calculated for a level 54 with values of the metric of turnover data. For example, the table may include estimated travel times for any level 54 corresponding to the metric of turnover data for a level 54. For another example, the table may include estimated travel times for particular levels 54 (the first, the second, etc.) corresponding to the metric of turnover data for the multilevel structure 50 as a whole.

Next, in a block 415, the computer 32 estimates the transition time for the multilevel structure 50 based on the turnover data for the multilevel structure 50. The transition time estimated in the block 415 plus the travel times estimated in the block 410 equal the estimated total time spent traveling in the multilevel structure 50. The memory of the computer 32 may store a table of estimated transition times corresponding to values of one of the metrics of turnover data. The table may be based on historical data from which average travel times may be calculated for a level 54 with values of the metric of turnover data. After the block 415, the process 400 ends.

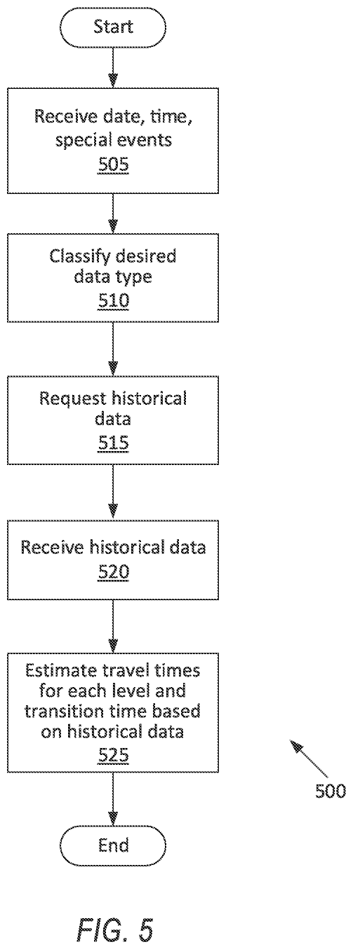

FIG. 5 is process flow diagram illustrating an exemplary process 500 for estimating travel times for each level 54 of the multilevel structure 50 based on historical data. Generally, the process 500 first classifies a type of historical data to use, such as by day and time or by whether a special event like a sports game is occurring nearby, and then requests historical data according to the classification to use for the travel times. The process 500 may be called as part of the process 300 or independently. The memory of the computer 32 stores executable instructions for performing the steps of the process 500. Alternatively or additionally, the executable instructions may be stored and performed on a remote server such as the cloud server 52.

The process 500 begins in a block 505, in which the computer 32 receives a current date and time and a status of special events. The current date and time may be stored in the memory of the computer 32 and constantly updated. The status of special events is whether an event is occurring in the area surrounding the multilevel structure 50 that will significantly affect traffic such as a sports game or a concert. Whether an event will significantly affect traffic may be determined by checking whether the capacity of the venue hosting the event is above a capacity threshold. The capacity threshold may be determined by comparing traffic delay deviations from average traffic delays when venues of a given capacity are hosting events. The status of special events may be received from the cloud server 52 or from another remote server. The status of special events may be determined by checking online calendars of nearby venues, such as stadiums and auditoriums, and/or calendars of a city in which the multilevel structure 50 is located.

Next, in a block 510, the computer 32 classifies the type of historical average travel times to request. If a special event is occurring, has ended within a first time period, or will begin within a second time period, then the type of historical average travel times will be a type of the special event and time relative to that special event, e.g., before a football game at stadium X, after a concert at auditorium Y, etc. The first and second time periods may be determined based on the historical extent of deviations from normal traffic patterns before and after special events. If no special event is occurring, then the type of historical average travel time will be based on the current date and time, e.g., current day of the week and hour of the day.

Next, in a block 515, the computer 32 requests from the cloud server 52 the historical average travel times matching the type, e.g., the historical average travel times of the current date and time and/or the historical average travel times matching the status of special events. The historical average travel times include times for each level 54 of the multilevel structure 50.

Next, in a block 520, the computer 32 receives the requested historical average travel times from the cloud server 52.

Next, in a block 525, the computer 32 calculates the estimated travel times for each level 54 based on the historical average travel times for the levels 54. Specifically, the historical average travel time of the requested type for each level 54 becomes the estimated travel time for that level 54. The computer 32 calculates the estimated transition time by using the historical average transition time. After the block 525, the process 500 ends.

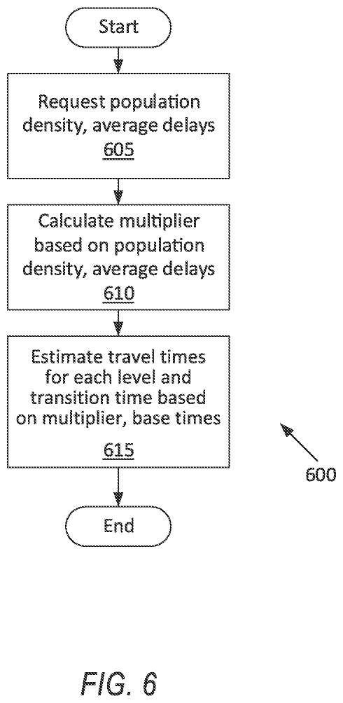

FIG. 6 is process flow diagram illustrating an exemplary process 600 for estimating travel times for each level 54 of the multilevel structure 50 based on data about the surrounding area. The process 600 may be called as part of the process 300 or independently. The memory of the computer 32 stores executable instructions for performing the steps of the process 600. Alternatively or additionally, the executable instructions may be stored and performed on a remote server such as the cloud server 52.

The process 600 begins in a block 605, in which the computer 32 requests data from the cloud server 52 pertaining to the geographic area surrounding the multilevel structure 50. For example, the computer 32 may request the population density and/or average current traffic delays for an area within a quarter mile of the multilevel structure 50.

Next, in a block 610, the computer 32 receives the requested data and calculates a multiplier based on the requested data. For example, the computer 32 may calculate the multiplier for each level 54 based on one or both of the population density and the average traffic delay of the area including the multilevel structure 50. One equation for a multiplier is A=K₁P+K₂D, in which A is the multiplier, K₁ is a first predetermined value, K₂ is a second predetermined value, P is the population density of the area, and D is the average traffic delay of the area. The predetermined values K₁ and K₂ may be stored in the memory. The predetermined values K₁ and K₂ may be determined experimentally based on tracking the locations of vehicles in multilevel structures and correlating with the population density and average traffic delays. The predetermined values K₁ and K₂ may be the same or different for different levels 54; if they are different, then there is a different multiplier for each level 54. The predetermined values K₁ and K₂ are not unique to any particular multilevel structure 50.

Next, in a block 615, the computer 32 estimates the travel times for each level 54 based on the multiplier. The computer 32 may multiply the multiplier by a baseline travel time for each level 54, e.g., T₁=AT_{b1}, T2=AT_{b2}, etc., in which Tᵢ is the estimated travel time for the ith level 54 and T_{bi} is the baseline travel time for the ith level 54. The baseline travel times may be, e.g., average times based on historical travel data over a variety of times and circumstances. The baseline travel times may be stored in the memory of the computer 32. After the block 615, the process 600 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

In the drawings, the same reference numbers indicate the same elements. Further, some or all of these elements could be changed. With regard to the media, processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary. Use of “in response to” and “upon determining” indicates a causal relationship, not merely a temporal relationship.

The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A system including a computer, the computer programmed to:
estimate a total travel time for a vehicle between an inside location in a multilevel structure and an outside location, wherein the estimated total travel time includes a sum of an estimated travel time between a specified point at the multilevel structure and the outside location and estimated travel times for each level of the multilevel structure between a level of the inside location and the specified point.

2. The system of claim 1, wherein the estimated total travel time further includes an estimated transition time one of into and out of the multilevel structure.

3. The system of claim 1, wherein the computer is programmed to calculate the estimated travel times for each level based on turnover data for the multilevel structure.

4. The system of claim 3, wherein the computer is programmed to calculate the estimated travel times for each level based on turnover data for each level.

5. The system of claim 1, wherein the computer is programmed to calculate the estimated travel times for each level based on historical average travel times for the levels.

6. The system of claim 5, wherein the historical average travel times are based on a current date and time.

7. The system of claim 5, wherein the historical average travel times are based on whether a special event is occurring.

8. The system of claim 5, wherein the computer is programmed to calculate the estimated travel times for each level based on historical average travel times for the levels upon determining that turnover data for the multilevel structure is unavailable.

9. The system of claim 1, wherein the computer is programmed to calculate the estimated travel times for each level based on one of population density and average traffic delay times of an area including the multilevel structure.

10. The system of claim 9, wherein the computer is programmed to calculate the estimated travel times for each level based on one of population density and average traffic delay times of an area including the multilevel structure upon determining that one of turnover data for the multilevel structure and historical average travel times for the levels is unavailable.

11. A method comprising:
estimating a total travel time for a vehicle between an inside location in a multilevel structure and an outside location, wherein the estimated total travel time includes a sum of an estimated travel time between a specified point at the multilevel structure and the outside location and estimated travel times for each level of the multilevel structure between a level of the inside location and the specified point.

12. The method of claim 11, wherein the estimated total travel time further includes an estimated transition time one of into and out the multilevel structure.

13. The method of claim 11, further comprising calculating the estimated travel times for each level based on turnover data for the multilevel structure.

14. The method of claim 13, further comprising calculating the estimated travel times for each level based on turnover data for each level.

15. The method of claim 11, further comprising calculating the estimated travel times for each level based on historical average travel times for the levels.

16. The method of claim 15, wherein the historical average travel times are based on a current date and time.

17. The method of claim 15, wherein the historical average travel times are based on whether a special event is occurring.

18. The method of claim 15, further comprising calculating the estimated travel times for each level based on historical average travel times for the levels upon determining that turnover data for the multilevel structure is unavailable.

19. The method of claim 11, further comprising calculating the estimated travel times for each level based on one of population density and average traffic delay times of an area including the multilevel structure.

20. The method of claim 19, further comprising calculating the estimated travel times for each level based on one of population density and average traffic delay times of an area including the multilevel structure upon determining that one of turnover data for the multilevel structure and historical average travel times for the levels is unavailable.
